(19) United States
(12) Patent Application Publication
(10) Pub. No.: US 2021/0108572 A1
(43) Pub. Date: Apr. 15, 2021

(54) ADVANCE RATIO FOR SINGLE UNDUCTED ROTOR ENGINE

(71) Applicant: General Electric Company, Schenectady, NY (US)

(72) Inventors: Syed Arif Khalid, West Chester, OH (US); Andrew Breeze-Stringfellow, Montgomery, OH (US)

(21) Appl. No.: 17/071,271

(22) Filed: Oct. 15, 2020

Related U.S. Application Data
(60) Provisional application No. 62/915,364, filed on Oct. 15, 2019.

(51) Int. Cl. F02C 9/00; F02C 7/36; F01D 5/12; F01D 9/02

(52) U.S. Cl. CPC F02C 9/00; F02C 7/36; F01D 5/12; F01D 9/02; F05D 2220/323; F05D 2240/60; F05D 2270/05; F05D 2270/304; F05D 2240/12

(57) ABSTRACT

A method is provided of operating a single unducted rotor engine, the single unducted rotor engine comprising a single stage of unducted rotor blades. The method includes operating the single unducted rotor engine to define a flight speed, V₀, in a length unit per second and an angular speed, n, in revolutions per second, the single stage of unducted rotor blades defining a diameter, D, in the length unit; wherein operating the single unducted rotor engine comprises operating the single unducted rotor engine to define an advance ratio greater than 3.8 while operating the single unducted rotor engine at a net efficiency of at least 0.8, the advance ratio defined by the equation V₀/(n×D).

### CROSS-REFERENCE TO RELATED APPLICATIONS

This application is a non-provisional application claiming the benefit of priority under 35 U.S.C. § 119(e) to U.S. Provisional Application No. 62/915,364, filed Oct. 15, 2019, which is hereby incorporated by reference in its entirety.

### FIELD

This application is generally directed to a single unducted rotor turbomachine engine, and a method for operating the same.

### BACKGROUND

A turbofan engine operates on the principle that a central gas turbine core drives a bypass fan, the bypass fan being located at a radial location between a nacelle of the engine and the engine core. With such a configuration, the engine is generally limited in a permissible size of the bypass fan, as increasing a size of the fan correspondingly increases a size and weight of the nacelle.

An open rotor engine, by contrast, operate on the principle of having the bypass fan located outside of the engine nacelle. This permits the use of larger rotor blades able to act upon a larger volume of air than for a traditional turbofan engine, potentially improving propulsive efficiency over conventional turbofan engine designs.

Desired performance has previously been found with an open rotor design having a fan with first and second rotor assemblies arranged in a contra-rotating configuration, with each rotor assembly carrying an array of airfoil blades. Typically, the blades of the first and second rotor assemblies are arranged to rotate about a common axis in opposing directions, and are axially spaced apart along that axis. For example, the respective blades of the first rotor assembly and second rotor assembly may be co-axially mounted and spaced apart, with the blades of the first rotor assembly configured to rotate clockwise about the axis and the blades of the second rotor assembly configured to rotate counter-clockwise about the axis (or vice versa). In appearance, the fan blades of an open rotor engine resemble the propeller blades of a conventional turboprop engine.

The use of contra-rotating rotor assemblies provides technical challenges in transmitting power from a power turbine of the open rotor engine to drive the blades of the respective two rotor assemblies in opposing directions. The inventors of the present disclosure have found that it would be desirable to provide an open rotor propulsion system utilizing a single rotating rotor assembly analogous to a traditional turbofan engine bypass fan which reduces the complexity of the design, yet yields a level of propulsive efficiency comparable to contra-rotating propulsion designs with a weight and length reduction.

### BRIEF DESCRIPTION

Aspects and advantages of the invention will be set forth in part in the following description, or may be obvious from the description, or may be learned through practice of the invention.

In an aspect of the present disclosure, a method is provided of operating a single unducted rotor engine, the single unducted rotor engine comprising a single stage of unducted rotor blades. The method includes operating the single unducted rotor engine to define a flight speed, V, in a length unit per second and an angular speed, n, in revolutions per second, the single stage of unducted rotor blades defining a diameter, D, in the length unit; wherein operating the single unducted rotor engine comprises operating the single unducted rotor engine to define an advance ratio greater than 3.8 while operating the single unducted rotor engine at a net efficiency of at least 0.8, the advance ratio defined by the equation V₀/(n×D).

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of a gas turbine engine in accordance with an exemplary aspect of the present disclosure.

FIG. 2 is a forward-looking-aft view of a rotor assembly in accordance with an exemplary embodiment of the present disclosure as may be incorporated into the gas turbine engine of FIG. 1.

FIG. 3 is a plan view along a radial direction of three exemplary rotor blade configurations.

FIG. 4 is a graph of exemplary advance ratio values of an engine in accordance with the present disclosure.

FIG. 5 is a flow diagram of a method for operating a single unducted rotor engine in accordance with an exemplary aspect of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The term “propulsive system” refers generally to a thrust-producing system, which thrust is produced by a propulsor, and the propulsor provides said thrust using an electrically-powered motor(s), a heat engine such as a turbomachine, or a combination of electric motor(s) and turbomachine.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

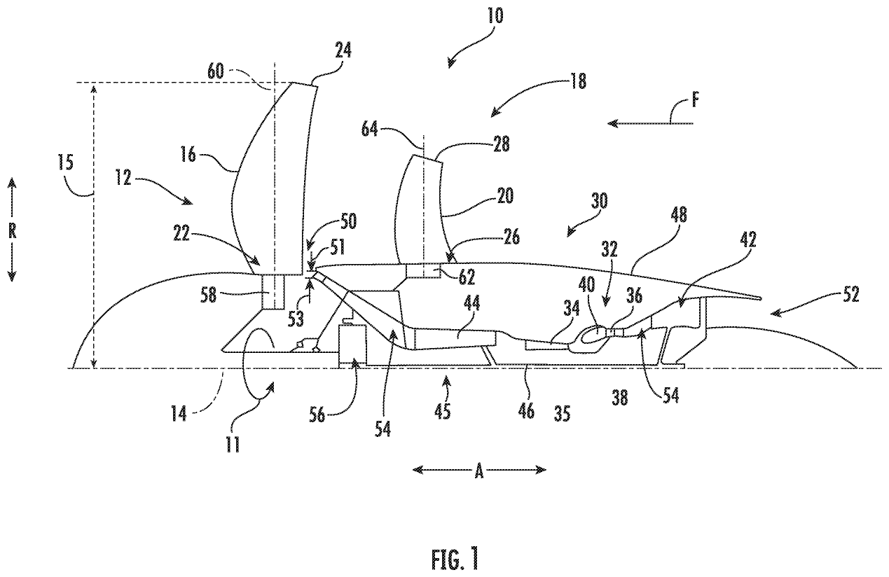

Referring now to the Drawings, FIG. 1 shows an elevational cross-sectional view of an exemplary embodiment of a gas turbine engine as may incorporate one or more inventive aspects of the present disclosure. In particular, the exemplary gas turbine engine of FIG. 1 is a configured as a single unducted rotor engine 10 defining an axial direction A, a radial direction R, and a circumferential direction (extending about the axial direction A). As is seen from FIG. 1, the engine 10 takes the form of an open rotor propulsion system and has a rotor assembly 12 which includes an array of airfoils arranged around a central longitudinal axis 14 of engine 10, and more particularly includes an array of rotor blades 16 arranged around the central longitudinal axis 14 of engine 10. The rotor assembly 12 is configured to rotate in the circumferential direction at an angular speed during operation, as is indicated by arrow 11.

Moreover, as will be explained in more detail below, the engine 10 additionally includes a non-rotating vane assembly 18 positioned aft of the rotor assembly 12 (i.e., non-rotating with respect to the central axis 14), which includes an array of airfoils also disposed around central axis 14, and more particularly includes an array of vanes 20 disposed around central axis 14. The rotor blades 16 are arranged in typically equally spaced relation around the centerline 14, and each blade has a root 22 and a tip 24 and a span defined therebetween. Similarly, the vanes 20 each have a root 26 and a tip 28 and a span defined therebetween. The rotor assembly 12 further includes a hub 43 located forward of the plurality of rotor blades 16.

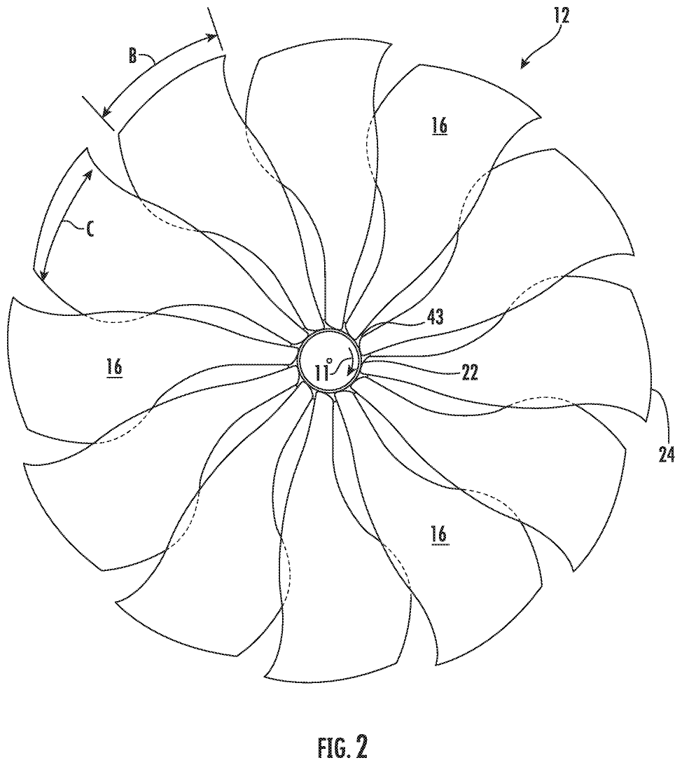

As will further be appreciated, the rotor assembly 12 defines a diameter, D, equal to two times a radius 15 shown in FIG. 1. For the embodiment show, the rotor assembly 12 may define a relatively large diameter, D, as will be described below. Moreover, additional details regarding the rotor blades 16 and vanes 20 will be provided in the discussion below with reference to, e.g., FIG. 2.

Referring still to FIG. 1, the engine 10 further includes a turbomachine 30 having core (or high speed system) 32 and a low speed system. The core 32 generally includes a high-speed compressor 34, a high speed turbine 36, and a high speed shaft 38 extending therebetween and connecting the high speed compressor 34 and high speed turbine 36. The high speed compressor 34 (or at least the rotating components thereof), the high speed turbine 36 (or at least the rotating components thereof), and the high speed shaft 38 may collectively be referred to as a high speed spool 35 of the engine. Further, a combustion section 40 is located between the high speed compressor 34 and high speed turbine 36. The combustion section 40 may include one or more configurations for receiving a mixture of fuel and air, and providing a flow of combustion gasses through the high speed turbine 36 for driving the high speed spool 35.

The low speed system similarly includes a low speed turbine 42, a low speed compressor or booster 44, and a low speed shaft 46 extending between and connecting the low speed compressor 44 and low speed turbine 42. The low speed compressor 44 (or at least the rotating components thereof), the low speed turbine 42 (or at least the rotating components thereof), and the low speed shaft 46 may collectively be referred to as a low speed spool 45 of the engine.

Although the engine 10 is depicted with the low speed compressor 44 positioned forward of the high speed compressor 34, in certain embodiments the compressors 34, 44 may be in an interdigitated arrangement. Additionally, or alternatively, although the engine 10 is depicted with the high speed turbine 36 positioned forward of the low speed turbine 42, in certain embodiments the turbines 36, 42 may similarly be in an interdigitated arrangement.

Referring still to FIG. 1, the turbomachine 30 is generally encased in a cowl 48. Moreover, it will be appreciated that the cowl 48 defines at least in part an inlet 50 of the turbomachine 30 and an exhaust 52 of the turbomachine 30, and includes a turbomachinery flowpath 54 extending between the inlet 50 and the exhaust 52. The inlet 50 is for the embodiment shown an annular or axisymmetric 360 degree inlet 50 located between the rotor blade assembly 12 and the fixed or stationary vane assembly 18, and provides a path for incoming atmospheric air to enter the turbomachinery flowpath 54 (and compressors 44, 34, combustion section 40, and turbines 36, 42) inwardly of the guide vanes 20 along the radial direction R. Such a location may be advantageous for a variety of reasons, including management of icing performance as well as protecting the inlet 50 from various objects and materials as may be encountered in operation.

As is further indicated in FIG. 1, the inlet defines an inlet area. The inlet area is defined by the equation: π(R₁²−R₂²), wherein R₁ is an outer measure 51 of the inlet 50 along the radial direction R, and R₂ is an inner measure 53 of the inlet 50 along the radial direction R. It will be appreciated that for the embodiment shown, a ratio of a frontal area (defined by an area of the rotor assembly 12, based on radius 15) to the inlet area is relatively high. Specifically, for the embodiment shown, the ratio of the frontal area to the inlet area is at least 20:1 and up to 100:1, such as up to 80:1. In such a manner, it will be appreciated that the rotor assembly 12 is relatively large as compared to the overall engine size and turbomachine 30 size. Such may contribute to an increase in efficiency of the engine 10.

It will be appreciated, however, that in other embodiments, the inlet 50 may be positioned at any other suitable location, e.g., aft of the vane assembly 18, arranged in a non-axisymmetric manner, etc., and the rotor assembly 12 may have any other suitable size relative to the turbomachine 30 of the engine 10.

As briefly mentioned above the engine 10 includes a vane assembly 18. The vane assembly 18 extends from the cowl 48 and is positioned aft of the rotor assembly 12. The vanes 20 of the vane assembly 18 may be mounted to a stationary frame or other mounting structure and do not rotate relative to the central axis 14. For reference purposes, FIG. 1 also depicts the forward direction with arrow F, which in turn defines the forward and aft portions of the system. As shown in FIG. 1, the rotor assembly 12 is located forward of the turbomachine 30 in a “puller” configuration, and the exhaust 52 is located aft of the guide vanes 20. As will be appreciated, the vanes 20 of the vane assembly 18 may be configured for straightening out an airflow (e.g., reducing a swirl in the airflow) from the rotor assembly 12 to increase an efficiency of the engine 10. For example, the vanes 20 may be sized, shaped, and configured to impart a counteracting swirl to the airflow from the rotor blades 16 so that in a downstream direction aft of both rows of airfoils (e.g., blades 16, vanes 20) the airflow has a greatly reduced degree of swirl, which may translate to an increased level of induced efficiency. Further discussion regarding the vane assembly 18 is provided below.

Referring still to FIG. 1, it may be desirable that the rotor blades 16, the vanes 20, or both, incorporate a pitch change mechanism such that the airfoils (e.g., blades 16, vanes 20, etc.) can be rotated with respect to an axis of pitch rotation either independently or in conjunction with one another. Such pitch change can be utilized to vary thrust and/or swirl effects under various operating conditions, including to adjust a magnitude or direction of thrust produced at the rotor blades 16, or to provide a thrust reversing feature which may be useful in certain operating conditions such as upon landing an aircraft, or to desirably adjust acoustic noise produced at least in part by the rotor blades 16, the vanes 20, or aerodynamic interactions from the rotor blades 16relative to the vanes 20. More specifically, for the embodiment of FIG. 1, the rotor assembly 12 is depicted with a pitch change mechanism 58 for rotating the rotor blades 16 about their respective pitch axes 60, and the vane assembly 18 is depicted with a pitch change mechanism 62 for rotating the vanes 20 about their respective pitch axes 64.

As is depicted, the rotor assembly 12 is driven by the turbomachine 30, and more specifically, is driven by the low speed spool 45. More specifically, the engine 10 in the embodiment shown in FIG. 1 includes a power gearbox 56 (also referred to as a reduction gearbox), and the rotor assembly 12 is driven by the low speed spool 45 of the turbomachine 30 across the power gearbox 56. The power gearbox 56 may include a gearset for decreasing a rotational speed of the low speed spool 45 relative to the low speed turbine 42, such that the rotor assembly 12 may rotate at a slower rotational speed than the low speed spool 45. In such a manner, the rotating rotor blades 16 of the rotor assembly 12 may rotate around the axis 14 and generate thrust to propel engine 10, and hence an aircraft to which it is associated, in a forward direction F.

More specifically, for the embodiment shown the power gearbox 56 defines a gear ratio for reducing the rotational speed of the rotor assembly 12 relative to the low pressure spool 45. In at least certain exemplary embodiments, the gear ratio may be greater than or equal to about 4:1 and less than or equal to about 12:1. For example, in certain exemplary embodiments, the gear ratio may be between greater than or equal to about 7:1 and less than or equal to about 12:1. In such a case, the power gearbox 56 may be a multi-stage or compound power gearbox (e.g., a planetary gearbox having compound planet gears, etc.). Inclusion of such a high gear ratio reduction gearbox 56 may facilitate a low angular speed during operation, which may contribute to an increased efficiency of the rotor assembly 12.

It will be appreciated, however, that the exemplary single rotor unducted engine 10 depicted in FIG. 1 is by way of example only, and that in other exemplary embodiments, the engine 10 may have any other suitable configuration, including, for example, any other suitable number of shafts or spools, turbines, compressors, etc.; any suitable fixed-pitched or variable-pitched rotor assembly 12 and/or vane assembly 18; any suitable power gearbox 56 configuration, etc.

Referring now to FIG. 2 the rotor assembly 12 will be described in greater detail. FIG. 2 provides a forward-facing-aft view of the rotor assembly 12 of the exemplary engine 10 of FIG. 1. For the exemplary embodiment depicted, the rotor assembly 12 includes twelve (12) blades 16. From a loading standpoint, such a blade count may allow a span of each blade 16 to be reduced such that the overall diameter, D, of rotor assembly 12 may also be reduced (e.g., to about twelve feet in the exemplary embodiment). That said, in other embodiments, rotor assembly 12 may have any suitable blade count and any suitable diameter. In certain suitable embodiments, the rotor assembly 12 includes at least eight (8) blades 16. In another suitable embodiment, the rotor assembly 12 may have at least twelve (12) blades 16. In yet another suitable embodiment, the rotor assembly 12 may have at least fifteen (15) blades 16. In yet another suitable embodiment, the rotor assembly 12 may have at least eighteen (18) blades 16. In one or more of these embodiments, the rotor assembly 12 includes twenty-six (26) or fewer blades 16, such as twenty (20) or fewer blades 16. Further, in certain exemplary embodiments, the rotor assembly 12 may define a diameter of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 16 feet.

In such a manner, it will be appreciated that the rotor assembly 12 defines a solidity, which is a conventional parameter relating the ratio of a blade chord C, as represented by its length, to a circumferential pitch B or spacing from blade to blade at the corresponding span position along the radial direction R. For example, the solidity may be equal to the average blade chord C times the number of fan blades, N, divided by the product of two (2) times pi (π) times a reference radius (Rref, which herein is a radius equal to 0.75 times a tip radius of a rotor blade, Rt) [C×N/(2×π×Rref)]. For the purpose comparison, solidity is based on average blade chord defined as the blade planform area (surface area on one side of a blade) divided by the blade radial span. The solidity is directly proportional to the number of blades and chord length and inversely proportional to the diameter. For the embodiment shown, the solidity is between 0.5 and 1, such as between 0.6 and 1. However, the solidity may in other embodiments be up to about 1.5, such as up to about 1.3.

Further, it will be appreciated that the vane assembly 18 includes vanes 20 arranged in a circumferential manner, in much the same way as the rotor blades 16 of the rotor assembly 12 are arranged. As such, it will further be appreciated that the vane assembly 18 may have any suitable vane count. In certain suitable embodiments, the vane assembly 18 includes at least four (4) vanes 20. In another suitable embodiment, the vane assembly 18 may have at least eight (8) vanes 20. In yet another suitable embodiment, the vane assembly 18 may have at least twelve (12) vanes 20. In yet another suitable embodiment, the vane assembly 18 may have at least eighteen (18) vanes 20. In one or more of these embodiments, the vane assembly 18 includes forty (40) or fewer vanes 20, such as twenty-six (26) or fewer vanes 20.

In various embodiments, it will be appreciated that the engine 10 includes a ratio of a quantity of vanes 20 to a quantity of blades 16 that could be less than, equal to, or greater than 1:1. For example, in certain embodiments, the engine 10 may include a ratio of a quantity of vanes 20 to a quantity of blades 16 between 1:2 and 5:2. The ratio may be tuned based on a variety of factors including a size of the vanes 20 to ensure a desired amount of swirl is removed for an airflow from the rotor assembly 12.

It should be appreciated that embodiments of the engine 10 including one or more ranges of ratios of blades 16 to vanes 31 depicted and described herein may provide advantageous improvements over turbofan or turboprop gas turbine engine configurations. In one instance, embodiments of the engine 10 provided herein may allow for thrust ranges similar to or greater than turbofan engines with a larger quantities of blades or vanes, while further obviating structures such as fan cases or nacelles. In another instance, embodiments of the engine 10 provided herein allow for thrust ranges similar to or greater than turboprop engines with similar quantities of blades, while further providing reduced noise or acoustic levels such as provided herein. In still another instance, embodiments of the engine 10 provided herein may allow for thrust ranges and attenuated acoustic levels such as provided herein while reducing weight, complexity, or issues associated with fan cases, nacelles, variable nozzles, or thrust-reverser assemblies at the nacelle.

It should further be appreciated that ranges of ratios of blades 16 to vanes 31 provided herein may provide particular improvements to gas turbine engines in regard to thrust output and acoustic levels. For instance, quantities of blades greater than those of one or more ranges provided herein may produce noise levels that may disable use of an open rotor engine in certain applications (e.g., commercial aircraft, regulated noise environments, etc.). In another instance, quantities of blades less than those ranges provided herein may produce insufficient thrust output, such as to render an open rotor engine non-operable in certain aircraft applications. In yet another instance, quantities of vanes less than those of one or more ranges provided herein may fail to sufficiently produce thrust and abate noise, such as to disable use of an open rotor engine in certain applications. In still another instance, quantities of vanes greater than those of ranges provided herein may result in increased weight that adversely affects thrust output and noise abatement.

It should be appreciated that various embodiments of the single unducted rotor engine depicted and described herein may allow for normal subsonic aircraft cruise altitude operation at or above Mach 0.5. In certain embodiments, the engine 10 allows for normal aircraft operation between Mach 0.55 and Mach 0.85 at cruise altitude. In certain embodiments, the engine 10 allows for fan tip speeds (i.e., the tip speeds of the rotor blades 16) at or less than 750 feet per second (fps). As will further be appreciated from the description herein, a loading of the rotor blades 16 of the rotor assembly may facilitate such flight speeds.

For example, in certain exemplary embodiments, the rotor blades 16 may define a power coefficient of at least 0.06 and up to 0.18 at a cruise flight condition. The term “power coefficient” as used herein refers to a measure calculated by the following formula: P/(ρ×A×V₀³), wherein “P” is power, “ρ” is ambient air density, “A” is the annular area of the propeller, and V₀ is the flight speed. Similarly, for example, in certain exemplary embodiments, the rotor blades 16 may define a thrust coefficient of at least 0.05 and up to 0.14. The term “thrust coefficient” as used herein refers to a measure calculated by the following formula: T/(ρ×A×V₀²), wherein “T” is thrust, “ρ” is ambient air density, “A” is the annular area of the propeller, and V₀ is the flight speed. It will be appreciated that, for configurations in which the engine inlet air stream passes through the propeller, as depicted in FIG. 1, the propeller thrust, power, and annular area correspond to thrust-generating stream, i.e., the portion of the propeller air stream that is outside of the engine inlet air stream. In such a manner, it will be appreciated that the term thrust, as used herein generally refers to propeller thrust, and not engine thrust. Similarly, it will be appreciated that as used herein, the term power refers to the power of the thrust stream from the propeller, not a total propeller shaft power. It will also be appreciated that the terms thrust coefficient and power coefficient refer to non-dimensional numbers, such that the values for power, thrust, ambient air density, annular area of the propeller, and flight speed may be expressed as any suitable unit, provided the units cancel out.

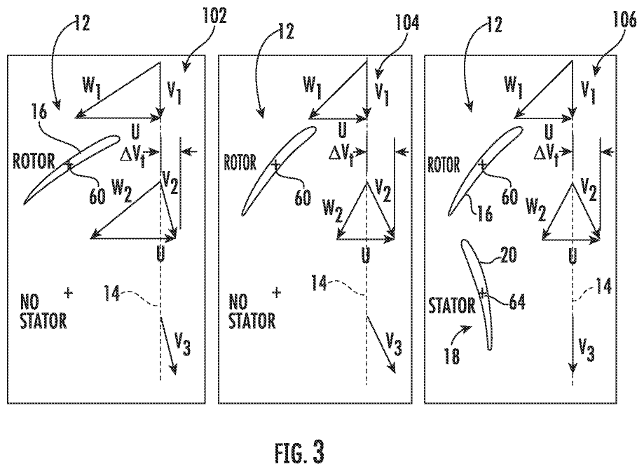

Referring now to FIG. 3, rotating rotor blades 16 of a rotor assembly 12 and stationary guide vanes 20 of a vane assembly 18 are depicted at a given radial location from a centerline axis 14 for various propulsor configurations. Firstly, however, it should be appreciated that a propulsion system (propulsor), such as a fan or propeller, generally generates thrust parallel to a rotational axis by transferring power from a shaft to the propulsor to accelerate the air. Power is the product of an angular speed of the shaft and a torque applied to the shaft. However, increasing the torque increases a magnitude of a tangential velocity, or swirl, imparted to the air through the propulsor. Notably, an energy in the swirl remaining in an exhaust stream of the propulsor does not contribute to a thrust generation and its kinetic energy is essentially wasted. Thus, to reduce the swirl for a given amount of power, a traditional single propeller may generally be constrained to run at relatively high angular speeds and relatively low torque levels, thereby reducing swirl. However, the inventors have found that it may be desirable to have a lower angular speed, e.g., to maintain mechanical rotational speed limits, to reduce noise generated by the blades, and/or to enable the rotor blades to operate at a higher efficiency.

To further illustrate this point, FIG. 3 depicts corresponding vector diagrams illustrating changes in air velocity over the rotor blades 16 and stator vanes 20 of three separate configurations—a left panel 102, a middle panel 104, and a right panel 106. A thick end of each rotor blades 16 is a leading edge. The rotor blades 16 are rotatable about their pitch axes 60 and the stator vanes 20 are rotatable about their pitch axes 64. Closing the rotor blades 16 is represented by a clockwise rotation of the rotor blades 16 about their pitch axis 60, whereas closing the stator vanes 20 is represented by a counter-clockwise rotation of the stator vanes 20 about their pitch axis 64. In the vector diagrams, subscript “1” refers to a condition forward of the rotor blades 16, “2” refers to a condition between the rotor blades 16 and stator vanes 20 (if included), and “3” is a condition aft of the stator vanes 20. The letter V refers to an absolute velocity of an airflow (which may also be referred to as an airspeed when incorporated into an engine incorporated into an aircraft), W refers to a velocity relative to a rotating frame of reference of the rotor assembly 12, and U indicates a magnitude and direction of a blade speed for the rotational speed and radial location. Axial and tangential velocity components are indicated by vertical and horizontal directions. A radial component (i.e., into and out of the view in FIG. 3) is minor and ignored for the sake of explanation.

The left panel 102 illustrates a rotor assembly 12 transferring power to an airflow at a relatively high angular speed with a relatively low torque applied to the rotor assembly 12. The middle panel 104 illustrates a rotor assembly 12 with the same power as depicted in the left panel, but at a lower angular speed and with a higher torque applied thereto. As discussed above, a torque applied to the rotor assembly 12 is directly related to a change in a tangential component of the velocity V (swirl), so for a given power input, a high angular speed keeps the exit swirl at a location downstream of the rotor assembly 12 relatively small. As such, it will be appreciated that the higher torque in the middle panel 102 results in a higher exit swirl and, thus, more wasted kinetic energy.

By contrast, the right panel 106 shows a rotor assembly 12 with the addition of a stator, or vane assembly 18, with the rotor assembly 12 operating at the same power as the left and middle panels 102, 104, and with a relatively low angular speed (as is also shown in the middle panel 104). Despite the relatively low angular speed of the rotor assembly 12 and the relatively high torque applied to the rotor assembly 12 in the right panel 106, and the swirl generated by the rotor assembly 12 as a result, an exit airflow downstream of the vane assembly 18 has no significant swirl. Thus, a combination of a rotor assemblyl2 and a vane assembly 18 may allow a rotor assembly 12 to be operated with a relatively high power, or rather at a relatively high power coefficient, (characterized by a relatively low angular speed and a relatively high amount of torque applied thereto), without wasting energy in the form of airflow swirl. Further, such may allow for rotation of the rotor assembly at a relatively low angular speed, which may generally translate to a higher rotor assembly efficiency.

In such a manner, it should be appreciated that a result of including the vane assembly 18 may be that the engine 10 incorporating such a rotor assembly 12 and vane assembly 18 may be operated with a more constant net efficiency over a larger range of advance ratios, as is explained below.

The net efficiency is an overall efficiency of the propulsor (e.g., the rotor assembly 12 and vane assembly 18) including the effects of friction losses and wasted kinetic energy of the stream, as well as removing the negative thrust (or adding the drag) of the spinner and casing (also referred to as the combined centerbody of the engine) for a given flight condition when the rotor blades and outlet guide vanes are not present. This may be referred to as the “blades-off” drag and is described in the American Institute of Aeronautics and Astronautics publication AIAA-1992-3770. For example, the net efficiency is generally a propulsive power (thrust multiplied by flight speed) divided by an input power. In particular, net efficiency may be characterized by the following formula: T×V₀/P; where “T” is thrust produced, “V₀” is flight speed, and “P” is power input to the rotor shaft. Net efficiency, as used herein, also refers to the net efficiency during cruise conditions for the aircraft.

Further, an advance ratio relates the true airspeed, V₀, to a rotational speed of the rotor assembly 12 and diameter, D, of the rotor assembly 12. Specifically, the advance ratio is computed accordingly to the following formula: V₀/(n×D), where “V₀ ” is flight speed in a length unit per second, “n” is an angular speed of the rotor assembly 12 in revolutions per second, and “D” is the diameter of the rotor assembly 12 in the same length unit used for V₀. With angular speed in the denominator, higher advance ratio values correspond to lower values of blade tip speed in comparison to the flight speed.

Further to the discussion above, it will be appreciated that an effect of including a vane assembly 18 is that an engine may extend operation of the propulsor (e.g., rotor assembly 12 and vane assembly 18) to larger advance ratios without overly degrading the net efficiency of the engine. For example, in certain exemplary embodiments, an engine operated in accordance with the present disclosure may define an advance ratio greater than or equal to about 2.8, such as greater than or equal to about 3.0, such as greater than or equal to about 3.3. For example, in certain exemplary embodiments, an engine operated in accordance with the present disclosure may define an advance ratio greater than or equal to about 3.8, such as greater than or equal to about 4.0, such as greater than or equal to about 4.2. Further, for example, in certain exemplary embodiments, an engine operated in accordance with the present disclosure may define an advance ratio up to about 9.0.

Notably, when the engine incorporates a vane assembly 18 in accordance with one or more of the exemplary embodiments described above, the engine 10 may further operate at a relatively high net efficiency for a given advance ratio. For example, in certain exemplary embodiments, the engine may be operated to define an advance ratio greater than 2.8, or 3.0, or 3.3, while also defining a net efficiency greater than or equal to 0.6, such as greater than or equal to 0.75, such as greater than or equal to 0.8, such as up to 0.9. For example, in certain exemplary embodiments, the engine may be operated to define an advance ratio greater than 3.8, while also defining a net efficiency greater than or equal to 0.6, such as greater than or equal to 0.75, such as greater than or equal to 0.8, such as up to 0.9. For example, in certain exemplary embodiments, the engine may be operated to define an advance ratio greater than 4.2, while also defining a net efficiency greater than or equal to 0.6, such as greater than or equal to 0.75, such as greater than or equal to 0.8, such as up to 0.9.

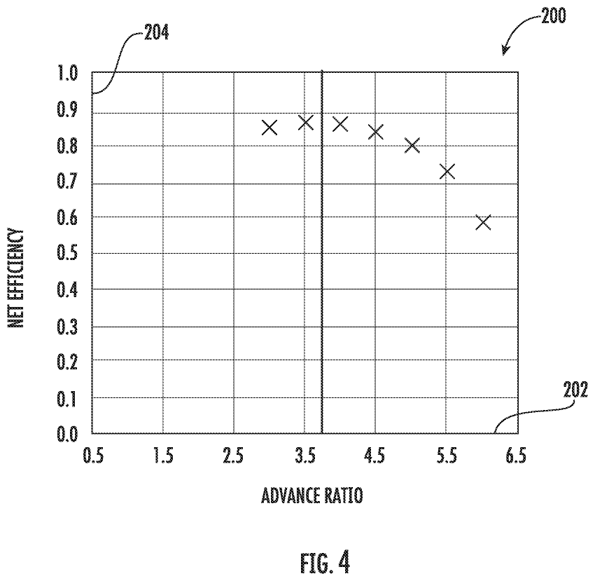

Briefly, referring now to FIG. 4, a graph 200 is depicted showing an exemplary operation of an engine in accordance with one or more exemplary embodiments of the present disclosure. The graph 200 depicts exemplary advance ratio values on the X-axis 202 and exemplary net efficiency values on the Y-axis 204. The exemplary engine may be configured in accordance with one or more of the above embodiments, and thus may be configured as a single unducted rotor engine having a stage of stationary guide vanes located relative to a single stage of unducted rotor blades to reduce a swirl in an airflow from the single stage of unducted rotor blades during operation. The graph depicts operation of the engine at relatively high flight speeds, such as greater than about Mach 0.7 and less than Mach 1, and between about Mach 0.7 and Mach 0.85. As will be appreciated, the exemplary engine configuration may allow for relatively efficient operation over a higher range of advance ratios than prior art engine configurations.

Such a benefit will further be appreciated from the following example configurations and operating conditions. These examples are provided for explanatory purposes only and are not meant to limit the scope of the present disclosure.

### EXAMPLE 1

An engine having a stage of unducted rotor blades defining a diameter, D, equal to 15 feet, a flight speed of approximately 765 feet per second (“fps”) true air speed during a maximum cruise operating condition, and an angular speed of the unducted rotor blades of 866 revolutions per minute (“rpm”) during the maximum cruise operating condition may define an Advance Ratio of approximately 3.5 during the maximum cruise operating condition corresponding to 37,000 feet (“ft”) altitude International Standard Atmosphere (“ISA”), 0.79 flight Mach number, 4000 pounds (“lb”) thrust, and propeller disk loading of 41 horsepower per square foot (“hp/ft²”). Also, as will be introduced below, the product of solidity and advance ratio is 2.0 and the product of blade count, solidity, and advance ratio is 20.

### EXAMPLE 2

An engine having a stage of unducted rotor blades defining a diameter, D, equal to 13 feet, a flight speed of approximately 765 fps true air speed during a maximum cruise operating condition, and an angular speed of the unducted rotor blades of 926 rpm during the maximum cruise operating condition may define an Advance Ratio of approximately 3.8 during the maximum cruise operating condition corresponding to 37,000 ft ISA, 0.79 flight Mach number, 4000 lb thrust, and propeller disk loading of 56 hp/ft². The product of solidity and advance ratio is 2.9 and the product of blade count, solidity, and advance ratio is 35.

### EXAMPLE 3

An engine having a stage of unducted rotor blades defining a diameter, D, equal to 16 feet, a flight speed of approximately 765 fps true air speed during a maximum cruise operating condition, and an angular speed of the unducted rotor blades of 477 rpm during the maximum cruise operating condition may define an Advance Ratio of approximately 6.0 during the maximum cruise operating condition corresponding to 37000 ft ISA, 0.79 flight Mach number, 4000 lb thrust, and propeller disk loading of 37 hp/ft². The product of solidity and advance ratio is 6.8 and the product of blade count, solidity, and advance ratio is 95.

In each of Examples 1, 2, and 3, the exemplary engines included a stage of unducted rotor blades having a number of rotor blades within the above ranges, and also included a stage of stationary outlet guide vanes having a number of outlet guide vanes within the above ranges. Additionally, in each of Examples 1, 2, and 3, the exemplary engines may define a loading of between 35 shaft horsepower per square feet (“SHP/ft^{2”) and} 80 SHP/ft², such as at least 48 SHP/ft², such as at least 50 SHP/ft², such as at least 53 SHP/ft², such as at least 55 SHP/ft², such as at least 57 SHP/ft², such as up to 65 SHP/ft², such as up to 63 SHP/ft².

Further, in each of Examples 1, 2, and 3, it was determined that with these configurations the engines of Examples 1, 2, and 3 were able to achieve relatively high efficiencies at the high advance ratios. For example, the engine in Example 1 had a net efficiency of approximately 0.84, the engine in Example 2 had a net efficiency of approximately 0.83, and the engine in Example 3 had a net efficiency of approximately 0.82. Moreover, it will be appreciated that the net efficiency of the engine in Example 1 was greater than the net efficiency of the engine in Example 2, which was in turn greater than the net efficiency of the engine in Example 3.

### EXAMPLE 4

An engine having a stage of unducted rotor blades defining a diameter, D, equal to 11 feet and a solidity equal to about 1.0; 12 rotor blades in the stage of unducted rotor blades; 10 stator vanes in the stage of stator vanes downstream of the stage of unducted rotor blades; a flight speed of approximately 730 fps true air speed (Mach 0.75 at 35000 ft ISA) during a cruise operating condition having 4000 lb thrust and 80 hp/ft² disk loading; and an angular speed of the unducted rotor blades of 894 rpm may define an Advance Ratio of approximately 4.5 during the maximum cruise operating condition with a net efficiency of 0.79. The product of solidity and advance ratio is 6.5 and the product of blade count, solidity, and advance ratio is 78.

### EXAMPLE 5

An engine having a stage of unducted rotor blades defining a diameter, D, equal to 11 feet and a solidity equal to about 1.0; 18 rotor blades in the stage of unducted rotor blades; 16 stator vanes in the stage of stator vanes downstream of the stage of unducted rotor blades; a flight speed of approximately 730 fps true air speed (Mach 0.75 at 35000 ft ISA) during a cruise operating condition; and an angular speed of the unducted rotor blades of 868 rpm may define an Advance Ratio of approximately 3.8 during the maximum cruise operating condition with a net efficiency of 0.82 having 4000 lb thrust and 80 hp/ft² disk loading. The product of solidity and advance ratio is 6.7 and the product of blade count, solidity, and advance ratio is 121.

The above Examples are summarized in Table 1, below, which may also provide some other parameters for these examples. In this Table, D is propeller diameter measured in feet, N is the number of propeller blades, RPM is revolutions per minute of the rotor blades, EFF is net efficiency, and J is advance ratio. In these examples, where the Mach number is 0.79, the altitude is 37,000 ft ISA, and where the Mach number is 0.75, the altitude is 35,000 ft ISA.

| Ex. # | D | N | Mach | V₀ | RPM | S | $\frac{SHP}{A}$ | $\frac{T}{ρ {AV}_{0}^{2}}$ | $\frac{P}{ρ {AV}_{0}^{3}}$ | EFF | J | S × J | N × S × J |
|---|---|---|---|---|---|---|---|---|---|---|---|---|---|
| 1 | 15 | 10 | 0.79 | 765 | 866 | 0.58 | 41 | 0.06 | 0.08 | 0.84 | 3.54 | 2.05 | 20 |
| 2 | 13 | 12 | 0.79 | 765 | 926 | 0.77 | 56 | 0.08 | 0.10 | 0.83 | 3.82 | 2.92 | 35 |
| 3 | 16 | 14 | 0.79 | 765 | 477 | 1.13 | 37 | 0.06 | 0.07 | 0.82 | 6.01 | 6.76 | 95 |
| 4 | 11 | 12 | 0.75 | 730 | 894 | 1.46 | 80 | 0.12 | 0.15 | 0.79 | 4.45 | 6.50 | 78 |
| 5 | 11 | 18 | 0.75 | 730 | 868 | 1.47 | 78 | 0.12 | 0.15 | 0.81 | 4.59 | 6.74 | 121 |

It has been found that by considering the product of the solidity, S, and advance ratio, J, there are unexpected benefits realized in terms of an overall design of a propulsive system (e.g., turbofan engine) especially well-suited for operating at a relatively high advance ratio with acceptable net efficiency at cruise conditions. For example, the product S×J can inform the skilled artisan of an operating space, which includes designing towards a more compact and higher loaded rotor of the propulsion system. The product S×J indicates a range of values, according to at least some embodiments, producing high values of advance ratio with acceptable net efficiency while also indicating the type of rotor design that should be selected. This rotor design indication is intended to mean such things as the dimensions or qualities of the rotor blades that are believed reasonable and practical for a rotor operating at high advance ratios. In other words, the product S×J indicates not only the operating range of interest, but also the type of rotor that is believed to provide superior results, given the constraints within which a rotor of a propulsive system may be selected, e.g., size, dimensions, weight of rotor blades, mission requirements, airframe type, etc. In still other embodiments, the product S×J×N may also, or alternatively be used to define the propulsive system operating at a relatively high advance ratio with acceptable net efficiency at cruise. N represents the number of blades for the rotor. By also considering the number of blades, one may account for a change in blade shed vorticity, which influences the net efficiency. Additionally, for a given advance ratio, an increase in N may positively affect the acoustic environment when the rotor is operating at cruise conditions. Such things as a propulsive system's requirements, its subsystem requirements, airframe integration needs and limitations, and performance capabilities may therefore be defined by the product of S and J, and optionally S, J and N.

In view of the foregoing objectives, in at least certain embodiments, a propulsion system is configured to define a S×J greater than 2.0, such as greater than 3.8, such as greater than 4.4, such as at least 6.0, up to 8.0.

In view of the foregoing objectives, in at least certain embodiments, a propulsion system is configured to define a S×J×N greater than 16, such as greater than 50, such as greater than 50, such as at least 72, and up to 150.

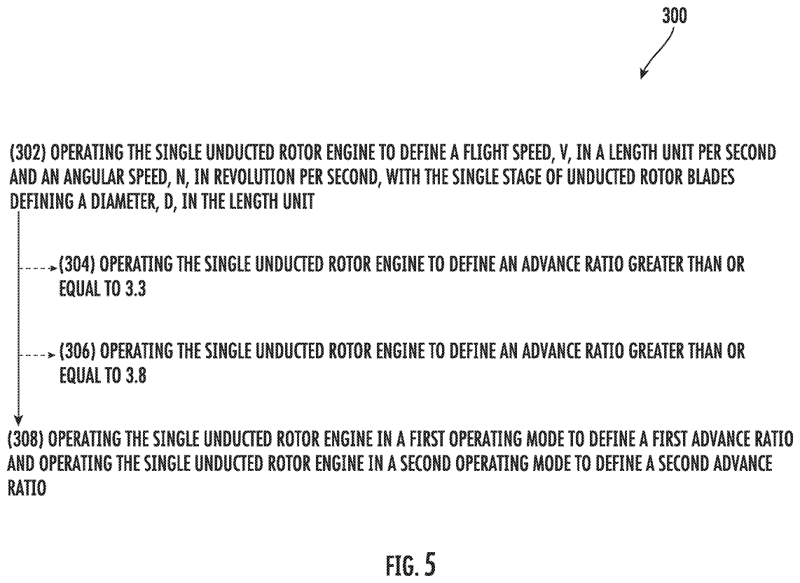

Referring now to FIG. 5, a flow diagram is provided of a method 300 for operating a single unducted rotor engine in accordance with an exemplary aspect of the present disclosure. In at least certain exemplary aspects, the method 300 may be used with one or more of the exemplary single unducted rotor engines described above with respect to FIGS. 1 through 4. As such, it will be appreciated that in at least certain exemplary aspects, the single unducted rotor engine may generally include a single stage of unducted rotor blades.

The method 300 includes at (302) operating the single unducted rotor engine to define a flight speed, V₀, in a length unit per second and an angular speed, n, in revolutions per second, with the single stage of unducted rotor blades defining a diameter, D, in the length unit. Operating the single unducted rotor engine at (302) may include operating an aircraft to define such a flight speed. Moreover, operating the single unducted rotor engine at (302) may include operating the single unducted rotor engine during powered operating conditions. As used herein, “powered” operating conditions refer to any anticipated powered operations of the engine (e.g., idle, cruise, climb, takeoff, etc.), but excludes any conditions wherein the engine isn't providing thrust (such as during a failure condition wherein the engine is windmilling).

In one exemplary aspect, the single unducted rotor engine may further include a stage of stationary guide vanes for reducing a swirl in an airflow from the single stage of unducted rotor blades. With such an exemplary aspect, operating the single unducted rotor engine at (302) may further include at (304) operating the single unducted rotor engine to define an advance ratio greater than or equal to about 3.3.

Additionally, or alternatively, operating the single unducted rotor engine at (302) may include at (306) operating the single unducted rotor engine to define an advance ratio greater than or equal to 3.8. For example, in certain exemplary aspects, operating the single unducted rotor engine at (302) may include operating the single unducted rotor engine to define an advance ratio greater than or equal to 3.8, or 4.0, such as greater than or equal to 4.2, such as less than or equal to about 9.0.

Referring still to FIG. 5, it will further be appreciated that for the exemplary aspect of the method 300 depicted in FIG. 5, operating the single unducted rotor engine at (302) further includes at (308) operating the single unducted rotor engine in a first operating mode to define a first advance ratio and operating the single unducted rotor engine in a second operating mode to define a second advance ratio. In at least certain exemplary aspects, the first operating mode may be a low flight speed operating mode and the second operating mode may be a high flight speed operating mode. With such an exemplary aspect, the first advance ratio may be less than the second advance ratio, with each greater than or equal to 3.3, or with each greater than or equal to 3.8, etc.

For example, in certain exemplary aspects, the first operating mode may be a cruise operating mode and the second operating mode may be a takeoff/climb operating mode. Additionally, or alternatively, the first operating mode may be a descent operating mode in the second operating mode may be a cruise operating mode.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

A method of operating a single unducted rotor engine, the single unducted rotor engine comprising a single stage of unducted rotor blades, the method comprising: operating the single unducted rotor engine to define a flight speed, V₀, in a length unit per second and an angular speed, n, in revolutions per second, the single stage of unducted rotor blades defining a diameter, D, in the length unit; wherein operating the single unducted rotor engine comprises operating the single unducted rotor engine to define an advance ratio greater than 2.8, 3.0, 3.3, Or 3.8 while operating the single unducted rotor engine at a net efficiency of at least 0.8, the advance ratio defined by the equation V₀/(n×D).

The method of one or more of these clauses, wherein operating the single unducted rotor engine to define the advance ratio greater than 3.8 comprises operating the single unducted rotor engine to define the advance ratio greater than 4.0.

The method of one or more of these clauses, wherein operating the single unducted rotor engine to define the advance ratio greater than 3.8 comprises operating the single unducted rotor engine to define the advance ratio greater than 4.2.

The method of one or more of these clauses, wherein operating the single unducted rotor engine to define the advance ratio greater than 3.8 comprises operating the single unducted rotor engine to define the advance ratio greater than 3.8 and less than 9.0.

The method of one or more of these clauses, wherein the single stage of unducted rotor blades comprises at least 8 unducted rotor blades and less than 26 unducted rotor blades.

The method of claim 1, wherein the single stage of unducted rotor blades defines a solidity between 0.5 and 1.0.

The method of one or more of these clauses, wherein the single unducted rotor engine further comprises a stage of stationary guide vanes having a plurality of stationary guide vanes located downstream of the single stage of unducted rotor blades for reducing a swirl in an airflow from the single stage of unducted rotor blades.

The method of one or more of these clauses, wherein a ratio of the number of stationary guide vanes in the stage of stationary guide vanes to the number of unducted rotor blades in the single stage of unducted rotor blades is at least 1:2 and up to 5:2

The method of one or more of these clauses, wherein the single unducted rotor engine comprises a turbine section having a turbine, a shaft rotatable with the turbine, and a reduction gearbox, wherein the single stage of unducted rotor blades is driven by the shaft across the reduction gearbox, and wherein the reduction gearbox defines a gear ratio of at least 7:1.

The method of one or more of these clauses, wherein the single unducted rotor engine comprises a turbomachine defining an inlet having an inlet area, wherein the single stage of unducted rotor blades defines a frontal area, and wherein a ratio of the frontal area to the inlet area is less than about 100:1 and at least 20:1.

The method of one or more of these clauses, wherein operating the single unducted rotor engine to define the advance ratio greater than 3.8 comprises operating the single unducted rotor engine in a first operating mode to define a first advance ratio and operating the single unducted rotor engine in a second operating mode to define a second advance ratio.

The method of one or more of these clauses, wherein the first operating mode is a low flight speed operating mode and wherein the second operating mode is a high flight speed operating mode, and wherein the first advance ratio is less than the second advance ratio.

The method of one or more of these clauses, wherein operating the single unducted rotor engine to define the advance ratio greater than 3.8 comprises operating the single unducted rotor engine at a net efficiency of up to 0.9.

The method of one or more of these clauses, wherein operating the single unducted rotor engine to define the advance ratio greater than 3.8 comprises operating the single unducted rotor engine with a power coefficient of at least 0.06 and up to 0.18 at a cruise flight condition, with a thrust coefficient of at least 0.05 and up to 0.14, or both.

The method of one or more of these clauses, comprising operating the engine in accordance is the parameters of Example 1 in Table 1.

The method of one or more of these clauses, comprising operating the engine in accordance is the parameters of Example 2 in Table 1.

The method of one or more of these clauses, comprising operating the engine in accordance is the parameters of Example 3 in Table 1.

The method of one or more of these clauses, comprising operating the engine in accordance is the parameters of Example 4 in Table 1.

The method of one or more of these clauses, comprising operating the engine in accordance is the parameters of Example 5 in Table 1.

The method of one or more of these clauses, comprising operating the engine to define parameters ranging between at least two of the Examples in Table 1.

A single unducted rotor engine comprising: a turbomachine; and an unducted rotor assembly driven by the turbomachine comprising a single row of a plurality of rotor blades, the plurality of rotor blades defining a diameter, D; wherein the single unducted rotor engine is configured to be operated to define a flight speed flight speed, V, measured in a length unit per second and an angular speed, n, measured in revolutions per second, wherein during operation the single unducted rotor engine is configured to define an advance ratio greater than 3.8 and a net efficiency of at least 0.8, the advance ratio defined by the equation V₀/(n×D).

The single unducted rotor engine of one or more of these clauses, wherein an outlet guide vane assembly comprising a plurality of outlet guide vanes located relative to the plurality of rotor blades for reducing a swirl in an airflow from the plurality of rotor blades.

The single unducted rotor engine of one or more of these clauses, wherein a ratio of the number of stationary guide vanes in the stage of stationary guide vanes to the number of unducted rotor blades in the single stage of unducted rotor blades is at least 1:2 and up to 5:2.

The single unducted rotor engine of one or more of these clauses, wherein a ratio of the number of stationary guide vanes in the stage of stationary guide vanes to the number of unducted rotor blades in the single stage of unducted rotor blades is 1:1.

The single unducted rotor engine of one or more of these clauses, wherein the turbomachine of the single unducted rotor engine comprises a turbine section having a turbine, a shaft rotatable with the turbine, and a reduction gearbox, wherein the unducted rotor assembly is driven by the shaft across the reduction gearbox, and wherein the reduction gearbox defines a gear ratio of at least 7:1.

A single unducted rotor engine comprising: a turbomachine; and an unducted rotor assembly driven by the turbomachine comprising a single row of a plurality of rotor blades, the single row of rotor blades comprising a total number of rotor blades, N, wherein the single unducted rotor engine defines a product of advance ratio and solidity of greater than 2.0; optionally greater than 2.9 and up to 8; optionally between about 1.8 and 3.5, optionally between about 3.2 and 6.5, and optionally between 4 and 5.

A single unducted rotor engine comprising: a turbomachine; and an unducted rotor assembly driven by the turbomachine comprising a single row of a plurality of rotor blades, the single row of rotor blades comprising a total number of rotor blades, N, wherein the single unducted rotor engine defines a product of advance ratio, N, and solidity of 16, optionally greater than 60, and up to 150, between 16 and 47, optionally between 51 and 92, and optionally between 40 and 75.

The single unducted rotor engine of one or more of these clauses, wherein a ratio of the number of stationary guide vanes in the stage of stationary guide vanes to the number of unducted rotor blades in the single stage of unducted rotor blades is at least 1:2 and up to 5:2.

The single unducted rotor engine of one or more of these clauses, wherein S*J is greater than 2.0, and wherein during operation the single unducted rotor engine is configured to define a net efficiency of at least 0.8.

The single unducted rotor engine of one or more of these clauses, wherein the solidity is between 0.5 and 1, such as between 0.6 and 1.

The single unducted rotor engine of one or more of these clauses, wherein the solidity is up to about 1.5, such as up to about 1.3.

The single unducted rotor engine of one or more of these clauses, wherein the advance ratio is greater than 3.8, such as greater than 4.0, such as greater than 4.2, such as greater than 4.5, such as greater than 4.7, such as greater than 5.0.

The single unducted rotor engine of one or more of these clauses, wherein the advance ratio is greater than about 3.8, such as greater than about 4.0, such as greater than about 4.2, such as greater than about 4.5, such as greater than about 4.7, such as greater than about 5.0, and wherein the solidity is greater than about 0.5, such as greater than about 0.7, such greater than about 0.9, such as greater than about 1.0, such as up to about 1.5, such as up to about 1.3.

The single unducted rotor engine of one or more of these clauses operated in accordance with a method of one or more of these clauses.

The single unducted rotor engine of one or more of these clauses, wherein the engine defines the parameters of Example 1 in Table 1.

The single unducted rotor engine of one or more of these clauses, wherein the engine defines the parameters of Example 2 in Table 1.

The single unducted rotor engine of one or more of these clauses, wherein the engine defines the parameters of Example 3 in Table 1.

The single unducted rotor engine of one or more of these clauses, wherein the engine defines the parameters of Example 4 in Table 1.

The single unducted rotor engine of one or more of these clauses, wherein the engine defines the parameters of Example 5 in Table 1.

The single unducted rotor engine of one or more of these clauses, wherein the engine defines parameters in a range bounded by two of the examples in Table 1.

The method of one or more of these clauses utilizing a single unducted rotor engine of one or more of these clauses.

A method of operating a propulsive system having a single unducted rotor, the propulsive system comprising a single stage of unducted rotor blades, the method comprising:

operating the propulsive system to define a flight speed, V₀, in a length unit per second and an angular speed, n, in revolutions per second, the single stage of unducted rotor blades defining a diameter, D, in the length unit;

wherein operating the propulsive system comprises operating the single unducted rotor engine to define an advance ratio greater than 3.8 while operating the single unducted rotor engine at a net efficiency of at least 0.8, the advance ratio defined by the equation V₀/(n×D).

A propulsive system having a single unducted rotor, comprising: a propulsor; and an unducted rotor assembly driven by the propulsor comprising a single row of a plurality of rotor blades, wherein the single unducted rotor engine is configured to define a product of advance ratio and solidity of greater than 2.0; optionally greater than 3.8; optionally greater than 5.0; optionally between 2.5 and 8.0.

A method of operating a propulsive system having a single unducted rotor, the propulsive system comprising a single stage of unducted rotor blades, the method comprising:

operating the propulsive system to define a flight speed, V₀, in a length unit per second and an angular speed, n, in revolutions per second, the single stage of unducted rotor blades defining a diameter, D, in the length unit;

wherein operating the propulsive system comprises operating the single unducted rotor engine to define an advance ratio greater than 3.8 while operating the single unducted rotor engine at a net efficiency of at least 0.8, the advance ratio defined by the equation V₀/(n×D).

A propulsive system having a single unducted rotor, comprising: a propulsor; and an unducted rotor assembly driven by the propulsor comprising a single row of a plurality of rotor blades, wherein the single unducted rotor engine is configured to define a product of advance ratio, number of the rotor blades, and solidity of about 6 up to about 150.

The propulsive system of one or more of these clauses, wherein a ratio of the number of stationary guide vanes in the stage of stationary guide vanes to the number of unducted rotor blades in the single stage of unducted rotor blades is at least 1:2 and up to 5:2.

The propulsive system of one or more of these clauses, wherein S*J is greater than 2.0, and wherein during operation the propulsive system is configured to define a net efficiency of at least 0.8.

The propulsive system of one or more of these clauses, wherein the solidity is between 0.5 and 1, such as between 0.6 and 1.

The propulsive system of one or more of these clauses, wherein the solidity is up to about 1.5, such as up to about 1.3.

The propulsive system of one or more of these clauses, wherein the advance ratio is greater than 3.8, such as greater than 4.0, such as greater than 4.2, such as greater than 4.5, such as greater than 4.7, such as greater than 5.0.

The propulsive system of one or more of these clauses, wherein the advance ratio is greater than about 3.8, such as greater than about 4.0, such as greater than about 4.2, such as greater than about 4.5, such as greater than about 4.7, such as greater than about 5.0, and wherein the solidity is greater than about 0.5, such as greater than about 0.7, such greater than about 0.9, such as greater than about 1.0, such as up to about 1.5, such as up to about 1.3.

The propulsive system of one or more of these clauses operated in accordance with a method of one or more of these clauses.

The method of one or more of these clauses utilizing a propulsive system of one or more of these clauses.

What is claimed:

1. A method of operating a single unducted rotor engine, the single unducted rotor engine comprising a single stage of unducted rotor blades, the method comprising:
operating the single unducted rotor engine to define a flight speed, V₀, in a length unit per second and an angular speed, n, in revolutions per second, the single stage of unducted rotor blades defining a diameter, D, in the length unit;
wherein operating the single unducted rotor engine comprises operating the single unducted rotor engine to define an advance ratio greater than 3.8 while operating the single unducted rotor engine at a net efficiency of at least 0.8, the advance ratio defined by the equation V/(n×D).

2. The method of claim 1, wherein operating the single unducted rotor engine to define the advance ratio greater than 3.8 comprises operating the single unducted rotor engine to define the advance ratio greater than 4.0.

3. The method of claim 1, wherein operating the single unducted rotor engine to define the advance ratio greater than 3.8 comprises operating the single unducted rotor engine to define the advance ratio greater than 4.2.

4. The method of claim 1, wherein operating the single unducted rotor engine to define the advance ratio greater than 3.8 comprises operating the single unducted rotor engine to define the advance ratio greater than 3.8 and less than 9.0.

5. The method of claim 1, wherein the single stage of unducted rotor blades comprises at least 8 unducted rotor blades and less than 26 unducted rotor blades.

6. The method of claim 1, wherein the single stage of unducted rotor blades defines a solidity between 0.5 and 1.0.

7. The method of claim 1, wherein the single unducted rotor engine further comprises a stage of stationary guide vanes having a plurality of stationary guide vanes located downstream of the single stage of unducted rotor blades for reducing a swirl in an airflow from the single stage of unducted rotor blades.

8. The method of claim 7, wherein a ratio of the number of stationary guide vanes in the stage of stationary guide vanes to the number of unducted rotor blades in the single stage of unducted rotor blades is at least 1:2 and up to 5:2.

9. The method of claim 7, wherein a ratio of the number of stationary guide vanes in the stage of stationary guide vanes to the number of unducted rotor blades in the single stage of unducted rotor blades is 1:1.

10. The method of claim 1, wherein the single unducted rotor engine comprises a turbine section having a turbine, a shaft rotatable with the turbine, and a reduction gearbox, wherein the single stage of unducted rotor blades is driven by the shaft across the reduction gearbox, and wherein the reduction gearbox defines a gear ratio of at least 7:1.

11. The method of claim 1, wherein the single unducted rotor engine comprises a turbomachine defining an inlet having an inlet area, wherein the single stage of unducted rotor blades defines a frontal area, and wherein a ratio of the frontal area to the inlet area is less than 100:1 and at least 20:1.

12. The method of claim 1, wherein operating the single unducted rotor engine to define the advance ratio greater than 3.8 comprises operating the single unducted rotor engine in a first operating mode to define a first advance ratio and operating the single unducted rotor engine in a second operating mode to define a second advance ratio.

13. The method of claim 12, wherein the first operating mode is a low flight speed operating mode and wherein the second operating mode is a high flight speed operating mode, and wherein the first advance ratio is less than the second advance ratio.

14. The method of claim 1, wherein operating the single unducted rotor engine to define the advance ratio greater than 3.8 comprises operating the single unducted rotor engine at a net efficiency of up to 0.95.

15. The method of claim 1, wherein operating the single unducted rotor engine to define the advance ratio greater than 3.8 comprises operating the single unducted rotor engine with a power coefficient of at least 0.06 and up to 0.18 at a cruise flight condition, with a thrust coefficient of at least 0.05 and up to 0.14, or both.

16. A single unducted rotor engine comprising:
a turbomachine; and
an unducted rotor assembly driven by the turbomachine comprising a single row of a plurality of rotor blades,
wherein the single unducted rotor engine defines a product of advance ratio and solidity of greater than 2.0 and less than 8.5.

17. The single unducted rotor engine of claim 16, wherein the single unducted rotor engine comprises an outlet guide vane assembly including a plurality of outlet guide vanes located relative to the plurality of rotor blades for reducing a swirl in an airflow from the plurality of rotor blades.

18. The single unducted rotor engine of claim 16, wherein the product of advance ratio and solidity is between about 1.8 and 3.5, optionally between 3.2 and 6.5, and optionally between 4 and 5.

19. The single unducted rotor engine of claim 16, wherein a ratio of the number of stationary guide vanes in the stage of stationary guide vanes to the number of unducted rotor blades in the single stage of unducted rotor blades is at least 1:2 and up to 5:2.

20. The single unducted rotor engine of claim 16, wherein the product of advance ratio and solidity is greater than 2.0, and wherein during operation the single unducted rotor engine is configured to define a net efficiency of at least 0.8.

21. The single unducted rotor engine of claim 16, wherein the turbomachine of the single unducted rotor engine comprises a turbine section having a turbine, a shaft rotatable with the turbine, and a reduction gearbox, wherein the unducted rotor assembly is driven by the shaft across the reduction gearbox, and wherein the reduction gearbox defines a gear ratio of at least 7:1.

22. A single unducted rotor engine comprising:
a turbomachine; and
an unducted rotor assembly driven by the turbomachine comprising a single row of a plurality of rotor blades,
wherein the single unducted rotor engine defines a product of a number of the rotor blades, advance ratio and solidity of greater than 16 and less than 150.

23. The single unducted rotor engine of claim 22, wherein the product of a number of the rotor blades, advance ratio and solidity is between 16 and 47, optionally between 51 and 92, and optionally between 40 and 75.

24. The single unducted rotor engine of claim 22, wherein the single unducted rotor engine comprises an outlet guide vane assembly including a plurality of outlet guide vanes located relative to the plurality of rotor blades for reducing a swirl in an airflow from the plurality of rotor blades.
